(19) United States
(12) Patent Application Publication
(10) Pub. No.: US 2026/0109054 A1
(43) Pub. Date: Apr. 23, 2026

(54) ROBOT HAND, METHOD FOR CONTROLLING ROBOT HAND, ROBOT SYSTEM, METHOD FOR MANUFACTURING ARTICLE USING ROBOT SYSTEM, AND RECORDING MEDIUM STORING CONTROL PROGRAM

(71) Applicant: CANON KABUSHIKI KAISHA, Tokyo (JP)

(72) Inventor: KOSUKE NISHIKAWA, Kanagawa (JP)

(21) Appl. No.: 19/353,331

(22) Filed: Oct. 8, 2025

(30) Foreign Application Priority Data
Oct. 21, 2024 (JP) 2024-185008

(51) Int. Cl. B25J 15/08; B25J 15/00

(52) U.S. Cl. CPC B25J 15/08; B25J 15/0033

(57) ABSTRACT

A robot hand includes a first finger portion and a second finger portion configured to grip a workpiece by approaching each other or separating from each other in a first direction, wherein each of the first finger portion and the second finger portion is provided with at least two edges configured to contact the workpiece, with an arc passing through at least three of the edges, and wherein, in the first direction, an edge among the at least three edges is provided on a side of a center of the arc opposite to a second direction in which the workpiece is to be attached, with the at least three of the edges being located on a side of the center of the arc in the second direction.

### BACKGROUND

### Field of the Technology

The present disclosure relates to a robot hand.

### Description of the Related Art

Generally, shaft parts mounted on industrial products, apparatuses, and the like require retaining rings for preventing a shaft from falling off in a longitudinal direction. Among retaining rings, E-shaped retaining rings (E-rings) have been widely used. An E-ring is fit into a groove formed at a shaft end. In particular, printers and other products having a paper conveyance mechanism use many shaft parts and many E-rings. In a common method for attaching an E-ring to a shaft, the E-ring is pinched with long-nose pliers, the opening of the E-ring is put on a shaft groove, and the E-ring is released. Then, the E-ring and the shaft are pinched together with the long-nose pliers in the direction perpendicularly intersecting with a longitudinal direction of the shaft (E-ring opening direction). Then, while being deformed, the E-ring is fit into the shaft groove. E-ring standards are prescribed in Japanese Industrial Standards (JIS) B 2085. Since almost all E-rings have a thickness of 1 mm or less, E-rings are difficult to be pinched with long-nose pliers. Since an E-ring has a circular shape, failure to pay attention to the gripping positions on the E-ring when pinching it with long-nose pliers may cause the pliers to slip along the circular shape. Since the E-ring attachment is considered to be difficult for the above described reasons, automated attachment has been demanded. Japanese Patent Laid-Open No. 2015-96290 discusses a robot hand for gripping a specialized tool for the E-ring attachment. The specialized tool described in Japanese Patent Laid-Open No. 2015-96290 has a form of holding the opposite side in the E-ring attachment direction (E-ring opening direction) and has a shape of a man catcher extending on the opposite side in the E-ring attachment direction. Japanese Patent Laid-Open No. 2015-96290 discusses a technique for gripping an E-ring with a specialized tool and attaching the E-ring from above the shaft groove in the E-ring attachment direction perpendicularly intersecting with the longitudinal direction of the shaft.

For example, in a case where an E-ring as a workpiece is attached, an available space for attachment may be insufficient. For example, if the specialized tool discussed in Japanese Patent Laid-Open No. 2015-96290 cannot access the space where the E-ring is to be attached, the E-ring attachment becomes difficult.

### SUMMARY

The present disclosure improves versatility in attaching a workpiece.

According to an aspect of the present disclosure, a robot hand is provided that includes a first finger portion and a second finger portion configured to grip a workpiece by approaching each other or separating from each other in a first direction. Each of the first finger portion and the second finger portion is provided with at least two edges configured to contact the workpiece, with an arc passing through at least three of the edges. In the first direction, an edge among the at least three edges is provided on a side of a center of the arc opposite to a second direction in which the workpiece is to be attached, with the at least three of the edges being located on a side of the center of the arc in the second direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B illustrate E-ring attachment according to an embodiment.

FIG. 2 is a schematic view illustrating a robot system according to an embodiment.

FIG. 3 is a block diagram illustrating the robot system according to an embodiment.

FIGS. 4A and 4B are schematic views each illustrating a robot hand according to an embodiment.

FIGS. 5A and 5B illustrate a comparison between a state where an E-ring is gripped by finger portions according to an embodiment and a state where the E-ring is gripped by different finger portions according to a comparative example.

FIG. 6 is a control flowchart according to an embodiment.

FIG. 7 illustrates the E-ring attachment according to an embodiment.

FIG. 8 illustrates the E-ring attachment according to an embodiment.

FIG. 9 illustrates the E-ring attachment according to an embodiment.

FIG. 10 illustrates the E-ring attachment according to an embodiment.

FIG. 11 illustrates the E-ring attachment according to an embodiment.

FIG. 12 illustrates a state where an E-ring is gripped by the finger portions according to an embodiment.

FIG. 13 illustrates the E-ring attachment according to an embodiment.

FIG. 14 illustrates the E-ring attachment according to an embodiment.

FIGS. 15A and 15B are schematic views each illustrating shapes of the finger portions according to an embodiment.

FIG. 16 is a schematic view illustrating shapes of the finger portions according to an embodiment.

### DESCRIPTION OF THE EMBODIMENTS

Embodiments for implementing the present disclosure will be described below with reference to the accompanying drawings.

The following embodiments are to be considered as illustrative. For example, detailed configurations can be suitably modified by those skilled in the art without departing from the spirit and scope of the present disclosure. Numeric values according to the present embodiment are to be considered as reference numerical values and do not limit the present disclosure. In the following drawings, arrows X, Y, and Z represent a coordinate system of an entire robot system. Generally, an XYZ three-dimensional coordinate system indicates the world coordinate system of the entire installation environment. In addition, depending on control conditions and other factors, a local coordinate system may be suitably used for robot hands, finger portions, joints, and the like. In description of the robot hand according to the present embodiment, an embodiment is provided in which a robot hand is used in a component holding apparatus that performs component retrieval, transfer, and assembly. However, the application of the robot hand according to the present embodiment is not limited to holding apparatuses.

### First Embodiment

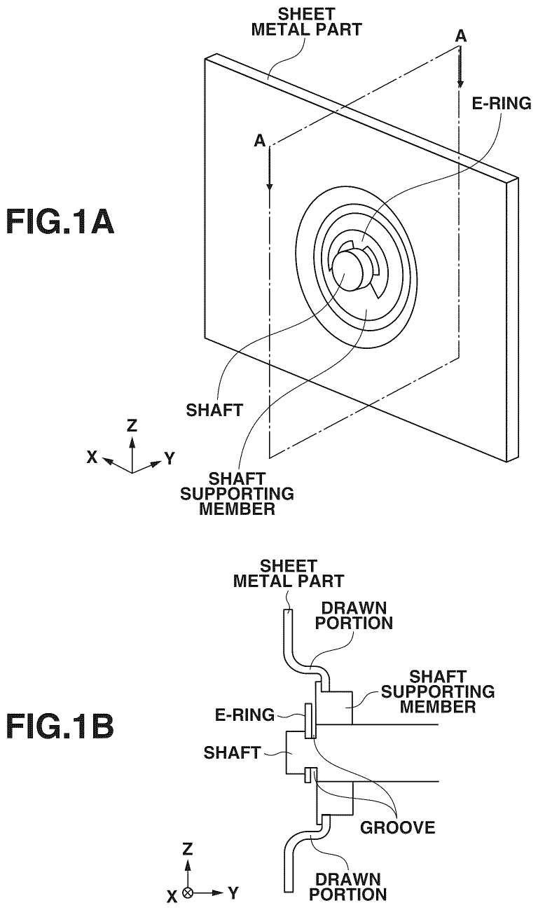

FIGS. 1A and 1B illustrate an example in which the space where an E-ring is to be attached is limited. FIG. 1A is a perspective view, and FIG. 1B is a cross-sectional view taken along a line AA in FIG. 1A. Referring to FIGS. 1A and 1B, a shaft is supported by a sheet metal part via a shaft supporting member. The shaft has a groove to which an E-ring is to be attached. A drawn portion of the sheet metal part is formed around the groove. The drawn portion of the sheet metal part is formed around the shaft groove to which the E-ring is to be attached. In the case of attachment of the E-ring onto the drawn portion of the sheet metal part as illustrated in FIGS. 1A and 1B, the area surrounding the groove on the shaft to which the E-ring is to be attached is obstructed by the drawn portion of the sheet metal part. As a result, access to the groove using a dedicated tool is not possible, making it difficult to attach the E-ring.

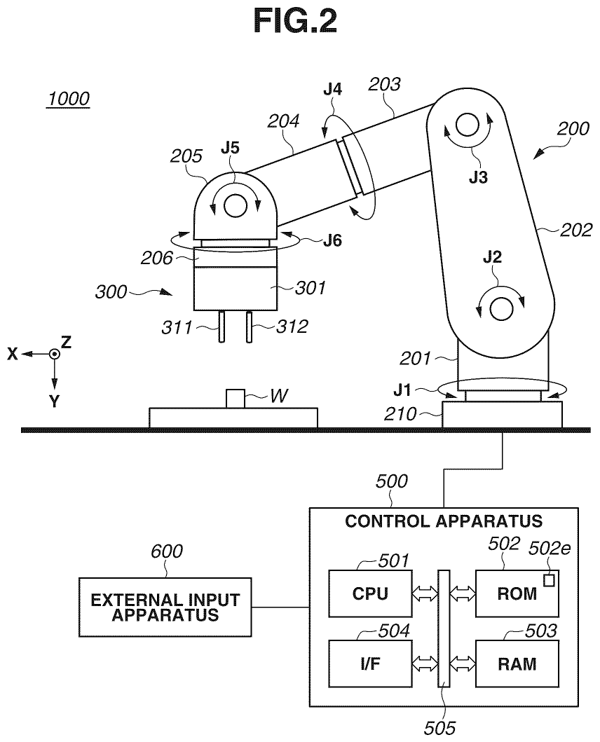

FIG. 2 illustrates an overall configuration of a robot system 1000 according to the first embodiment. The robot system 1000 according to the present embodiment includes a robot arm 200, a robot hand 300, a control apparatus 500, and an external input apparatus 600. A workpiece W is operated with the robot arm 200 and the robot hand 300. The workpiece W is an E-ring or the like. The external input apparatus 600 is connected to the control apparatus 500 via an interface (I/F) 504. The external input apparatus 600 includes, for example, a teaching pendant including a touch panel, which may include a Graphical User Interface (GUI).

The robot arm 200 is an articulated robot arm, and the base of the robot arm 200 is fixed in the present embodiment. The robot arm 200 includes a base unit 210 and a plurality of links 201, 202, 203, 204, 205, and 206 which are joined by, respectively, a plurality of joints J1, J2, J3, J4, J5 and J6. The plurality of joints J1 to J6 are driven to rotate. The link 201 is joined to the base unit 210. Each joint of the robot arm 200 includes a motor serving as a driving source for driving the joint, a speed reducer, and an encoder serving as a position detection unit for detecting the rotational angle of the motor. The installation position and output format of the encoder are not particularly limited. Each joint may also be provided with a torque sensor for acquiring force information. The robot hand 300 is attached to the link 206 at the leading end of the robot arm 200. The robot hand 300 and the link 206 can be rotated by the joint J6. Driving the joints J1 to J6 of the robot arm 200 enables the robot arm 200 to take various orientations and enables the robot hand 300 to take various positions and orientations.

The robot hand 300 serving as an end effector is attached to the link 206 of the robot arm 200. The robot hand 300 includes a hand base 301 that is provided with finger portions 311 and 312. The finger portion 311 may be referred to as a first finger portion, and the finger portion 312 may be referred to as a second finger portion.

The control apparatus 500 includes a Central Processing Unit (CPU) 501, a Read Only Memory (ROM) 502, a Random Access Memory (RAM) 503, and the I/F 504 for communicating with external devices. These devices are configured to communicate with each other via a bus 505. The ROM 502 stores programs for controlling drive units corresponding to various operations of the robot arm 200, and data required for such control.

The RAM 503 serves as a working area of the CPU 501.

The ROM 502 records a program 502e for causing a computer, namely, CPU 501, to execute instructions for controlling the robot arm 200, the robot hand 300, and other apparatuses. The RAM 503 is used to temporarily store programs for controlling the entire system and data such as execution timings and control commands for operations of control targets. The CPU 501 receives, for example, data transmitted from various sensors, via the I/F 504. The CPU 501 can transmit commands as control target values to the control apparatus 500 for controlling the corresponding control targets based on the programs and data input by a user, via the I/F 504.

Although, in the present embodiment, the program 502e is recorded in the ROM 502, the present disclosure is not limited thereto. The program 502e may be recorded in a recording medium of any type as long as the recording medium is a computer-readable non-transitory recording medium. Examples of recording media for supplying the program 502e to the computer include a flexible disk, hard disk, optical disk, magneto-optical disk, magnetic tape, and nonvolatile memory.

The I/F 504 functions as an interface for communicating with the robot arm 200, the robot hand 300, and the external input apparatus 600. The CPU 501 calculates the angle to be achieved by each joint with respect to the target position and orientation of the leading end of the robot arm 200, which is the movement destination of the robot hand 300. Then, the CPU 501 outputs command values to servo circuits for controlling the motors of the joints via the I/F 504 to control the drive of the joints of the robot arm 200. This enables the robot hand 300 to operate the workpiece W.

The external input apparatus 600 may be an operation apparatus, such as a teaching pendant (TP), but may also be another computer apparatus, such as a personal computer (PC) or a server, capable of editing robot programs. The external input apparatus 600 can be connected to the control apparatus 500 via a wired or wireless communication connection unit, and has user interface functions, such as robot operations and status display. The CPU 501 receives, for example, teaching point data input to the external input apparatus 600, from the I/F 504. The CPU 501 can generate trajectories for the robot arm 200 and the robot hand 300 based on the teaching point data input from the external input apparatus 600, and transmit the trajectories as control target values to the robot arm 200 and the robot hand 300 via the I/F 504. In the present embodiment, an example has been described in which the CPU 501 performs control. However, the present disclosure is not limited thereto. Control may be performed by at least one CPU, including a plurality of CPUs, or by a multi-core CPU.

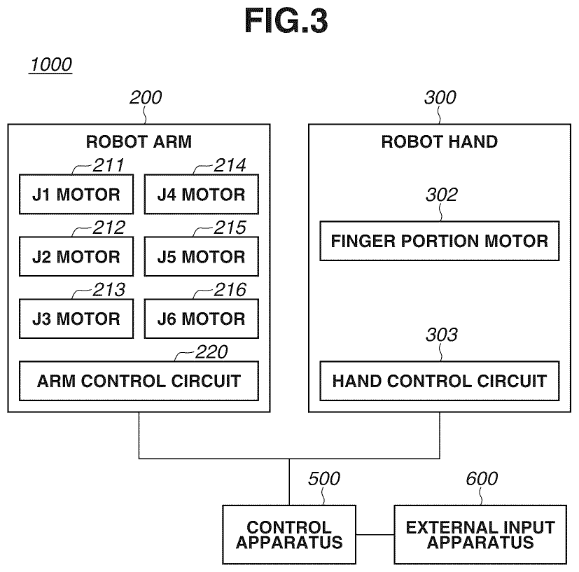

FIG. 3 is a block diagram illustrating a structure of the control system in the robot system 1000 according to the present embodiment. As illustrated in FIG. 3, the robot hand 300 includes a finger portion motor 302 for moving the finger portions 311 and 312 toward or away from each other, and a hand control circuit 303 for controlling the finger portion motor 302. The control apparatus 500 transmits a command to the hand control circuit 303. The hand control circuit 303 controls the finger portion motor 302 to operate according to the command from the control apparatus 500. The finger portions 311 and 312 are configured to be driven by the operation of the finger portion motor 302. Thus, the control apparatus 500 transmits a command to the hand control circuit 303 to cause the robot hand 300 to grip or release the workpiece W.

The robot arm 200 includes a J1 motor 211, a J2 motor 212, a J3 motor 213, a J4 motor 214, a J5 motor 215, and a J6 motor 216 for driving the joints J1 to J6, specifically, the links 201 to 206, respectively. The robot arm 200 also includes an arm control circuit 220 for controlling these motors. The control apparatus 500 transmits commands to the arm control circuit 220 based on the teaching data. The arm control circuit 220 controls each motor to operate according to commands from the control apparatus 500. Thus, the control apparatus 500 can swivel or rotate the links 201 to 206 by transmitting commands to the arm control circuit 220. Accordingly, the control apparatus 500 can move the robot hand 300 to the taught position and adjust its orientation in a workspace where the robot system 1000 is disposed. Each of the J1 motor 211, J2 motor 212, J3 motor 213, J4 motor 214, J5 motor 215, and J6 motor 216 may be provided with a control circuit.

With above-described configuration, the robot arm 200 can move the robot hand 300 to any desired position to perform a predetermined operation. For example, by using a predetermined workpiece and another workpiece as materials and performing processing for attaching the predetermined workpiece and the other workpiece, an assembled workpiece can be produced as a finished product. In addition to assembling workpieces, the robot hand 300 may also grip a predetermined tool to process a predetermined workpiece for manufacturing. Accordingly, the robot system 1000 enables the manufacturing of articles.

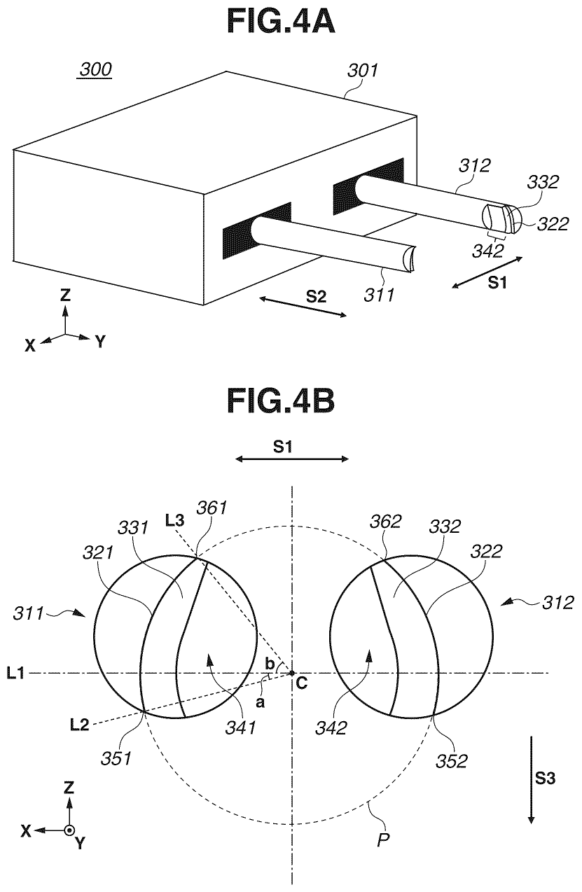

FIGS. 4A and 4B provide schematic views illustrating the robot hand 300 according to the present embodiment. FIG. 4A is a perspective view illustrating the robot hand 300. FIG. 4B is an XZ plan view illustrating the finger portions 311 and 312. FIG. 4B does not illustrate the hand base 301 for the conciseness. As illustrated in FIG. 4A, the robot hand 300 is provided with the finger portions 311 and 312 having symmetrical shapes. The finger portions 311 and 312 are made of a metallic material such as Steel Use Stainless (SUS, a stainless steel designation under Japanese Industrial Standards) and the like. The finger portions 311 and 312 are movable relative to the hand base 301 and are configured to approach each other or separate from each other in S1 direction in a coordinated manner. The longitudinal direction of the finger portions 311 and 312 is represented as S2.

As illustrated in FIGS. 4A and 4B, the finger portions 311 and 312 include gripping surfaces 321 and 322 for griping an E-ring, respectively, and supporting surfaces 331 and 332 for supporting a surface of the E-ring, respectively. The gripping surfaces 321 and 322 have circular arc shapes to fit the outer shape of the E-ring, making it possible to grip the E-ring with the entire gripping surfaces. Relief portions 341 and 342 are shaped to prevent the shaft serving as the attachment target from interfering with the finger portions 311 and 312 during the E-ring attachment.

Referring to FIG. 4B, the finger portions 311 and 312 are positioned to grip the E-ring. In the state illustrated in FIG. 4B, a circular arc P passing through edges 351 and 352, which are located on the gripping surfaces 321 and 322, respectively, on a forward side in an S3 direction (E-ring attachment direction), and edges 361 and 362, which are located on the gripping surfaces 321 and 322, respectively, on the opposite side in the S3 direction matches the outer shape of the E-ring. A line segment L1 passes through the center C of the circular arc P in parallel with S1 direction (approach/separation direction of the finger portions 311 and 312). An angle a is formed between the line segment L1 and a line segment L2 passing through the center C of the circular arc P and the edge 351. An angle b is formed between the line segment L1 and a line segment L3 passing through the center C of the circular arc P and the edge 361. In this case, according to the present embodiment, the gripping surfaces 321 and 322 are formed so that the angle a is smaller than the angle b. The angle a may be 12 degrees or less and the angle b may be 45 degrees or more are desirable, though the present disclosure is not limited thereto. The positional relations between the edges 351, 352, 361, and 362 enable the E-ring gripped by the robot hand 300 to withstand a reactive force occurring during the E-ring attachment, without hindering the deformation of the E-ring during the E-ring attachment. The gripping surface 321 may be referred to as a first surface, the gripping surface 322 may be referred to as a second surface, the supporting surface 331 may be referred to as a third surface, and the supporting surface 332 may be referred to as a fourth surface.

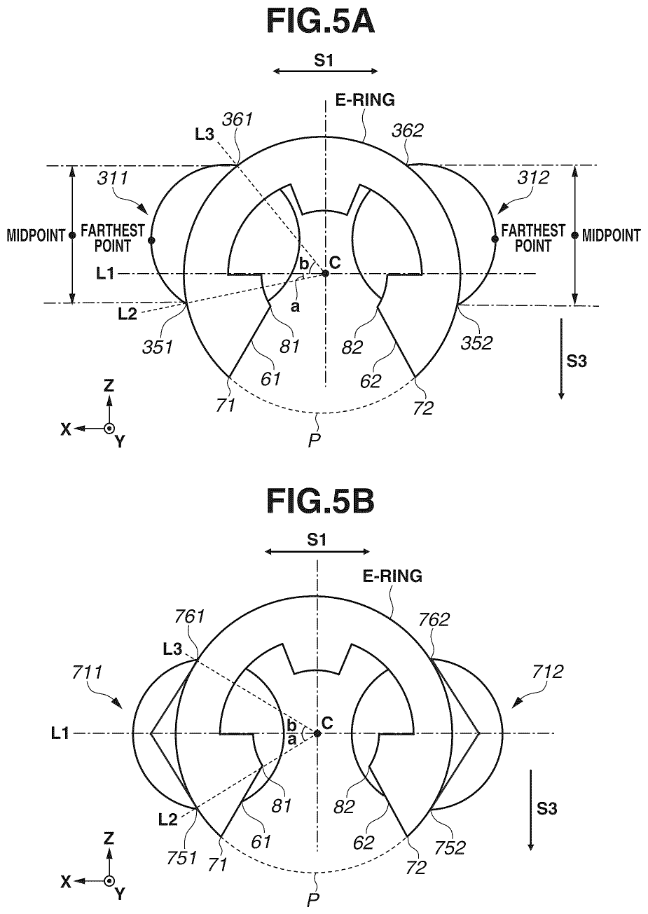

FIGS. 5A and 5B are diagrams for comparing the E-ring (workpiece) gripping by the robot hand 300 according to the present embodiment with the E-ring gripping by the robot hand 700 according to a comparative example. FIG. 5A illustrates the E-ring gripped by the robot hand 300 according to the present embodiment, and FIG. 5B illustrates the E-ring gripped by the robot hand 700 according to the comparative example.

Referring to FIG. 5B, the robot hand 700 according to the comparative example includes finger portions 711 and 712. The finger portions 711 and 712 illustrated in FIG. 5B are positioned gripping the E-ring. In the state in FIG. 5B, a circular arc P passing through edges 751 and 752 on the forward side in the S3 direction, which is the E-ring attachment direction, and edges 761 and 762 on the opposite side matches the outer shape of the E-ring. A line segment L1 passes through a center C of the circular arc P in parallel with the S1 direction, which are the approach and separation directions of the finger portions 711 and 712. An angle a is formed between the line segment L1 and a line segment L2 passing through the center C of the circular arc P and the edge 751. An angle b is formed between the line segment L1 and a line segment L3 passing through the center C of the circular arc P and the edge 761. In this case, according to the comparative example, the edges 751, 752, 761, and 762 are formed so that the angle a equals the angle b. The finger portions 711 and 712 according to the comparative example have the same outer diameter as the finger portions 311 and 312 according to the present embodiment. The line segment L1 may be referred to as a first line segment, the line segment L2 a second line segment, and the line segment L3 a third line segment. The angle a may be referred to as a first angle, and the angle b a second angle.

As illustrated in FIG. 5A, since the angle a is smaller than the angle b, the distance between the edge 351 and a workpiece edge 71 that is adjacent to the notch in the E-ring, and the distance between the edge 352 and a workpiece edge 72 that is adjacent to an opposite side of the notch surface of the E-ring is greater than the similar distance in the comparative example. As illustrated in FIG. 5B, this distance can be made longer than the distance between the edge 751 and the workpiece edge 71 of the notch surface of the E-ring, and the distance between the edge 752 and the workpiece edge 72 of the notch surface of the E-ring. Further, the E-ring deforms in the S1 direction while being attached to the shaft, causing the workpiece edges 71 and 72 of the notched surface of the E-ring to deform significantly, thereby resulting in a tendency to expand the gripping positions in the S1 direction. In contrast, in the present embodiment the edges 351 and 352 are positioned further away from the workpiece edges 71 and 72 on the notch surfaces of the E-ring, respectively, so that displacement of the gripping position due to deformation of the E-ring is minimized, thus achieving stable gripping.

In the S1 direction, which are approach and separation directions of the finger portions 311 and 312, the edge 361 is positioned on the center C side of the edge 351. Similarly, in the S1 direction, which are approach and separation directions of the finger portions 311 and 312, the edge 362 is positioned on the center C side of the edge 352. Further, in the S1 direction, which are approach and separation directions of the finger portions 311 and 312, the edges 351 and 361 are positioned on the center C side of a point on the finger portion 311 farthest from the center C. Further still, in the S1 direction, which are approach and separation directions of the finger portions 311 and 312, the edges 352 and 362 are positioned on the center C side of the point on the finger portion 312 farthest from the center C. The midpoint between the edges 351 and 361 in the S3 direction, which is the E-ring attachment direction, and the midpoint between the edges 352 and 362 in the S3 direction, which is the E-ring attachment direction, are positioned on the opposite side in the S3 direction with respect to the center C.

Thus, as compared with the comparative example, the present embodiment reduces the influence of E-ring deformation, during assembly, on the finger portions 311 and 312, thus allowing the E-ring to be stably gripped. In particular, when the angle a is 12 degrees or less as in the present embodiment illustrated in FIG. 5A, the gripping positions of the E-ring can be further separated from other workpiece edges 81 and 82 of the notch surfaces. Accordingly, the influence of E-ring deformation on the finger portions 311 and 312 can be further reduced.

Since the angle b is larger than the angle a, as illustrated in FIG. 5A, the edges 361 and 362 can be more favorably positioned for receiving the attachment reactive force in the direction opposite to the S3 direction, which is the E-ring attachment direction. According to the comparative example illustrated in FIG. 5B, the edges 761 and 762 are less favorably positioned for receiving the attachment reactive force in the direction opposite to the S3 direction, which is the E-ring attachment direction, making the E-ring more prone to slipping relative to the finger portions 711 and 712. In particular when the angle b is 45 degrees or larger as in the present embodiment illustrated in FIG. 5A, the edges 761 and 762 can receive the attachment reactive force through the rigidity of the finger portions without depending on the friction force on the gripping surfaces dependent on the gripping force. This allows for more stable retention of the E-ring. The angle b of 75 degrees or less is desirable because the increase in the angle b will increase the finger portions 311 and 312 in size with respect to the E-ring and make it more difficult for the finger portions to enter a small space. In particular, there is an attachment stroke in the S3 direction, which is the E-ring attachment direction, and the E-ring is accessed from above the shaft. Therefore, a space allowing the access of the E-ring is secured.

As in the present embodiment illustrated in FIG. 5A, the angle a is smaller than angle b (especially, angle a≤12 degrees, 45 degrees≤angle b≤75 degrees). Rather than equalizing the angles a and b as in the comparative example illustrated in FIG. 5B, making the angle a larger than the angle b enables the finger portions 311 and 312 to withstand the reactive force during the E-ring attachment while receiving the force resulting from the E-ring deformation during the E-ring attachment. Therefore, the finger portions 311 and 312 according to the present embodiment are provided with finger portion-tip shapes suitable for the E-ring attachment. Such finger portion-tip shapes enable the finger portions 311 and 312 to grip the E-ring with respective finger portion tips, enter a small space, and perform the E-ring attachment.

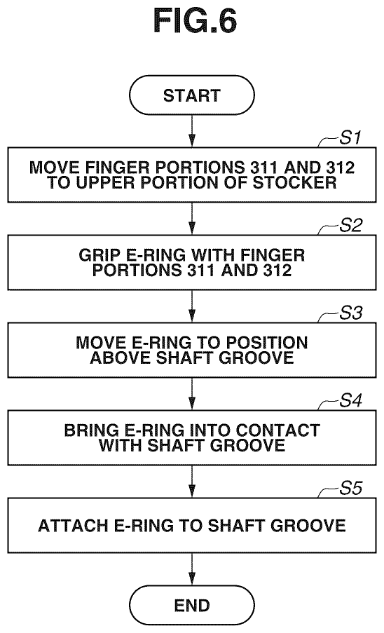

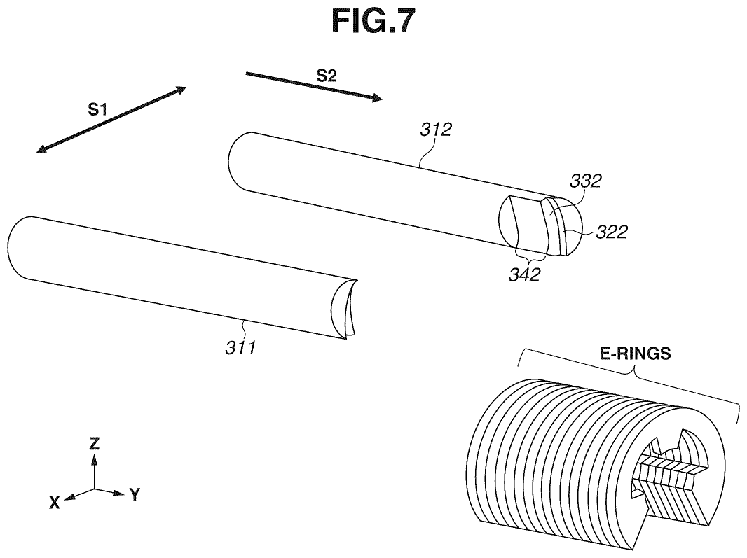

A method for attaching an E-ring by using the robot hand 300 according to the present embodiment will now be described. FIG. 6 is a control flowchart illustrating procedures for attaching the E-ring using the robot hand 300. FIGS. 7 to 11 illustrate a state where the E-ring is attached according to the present embodiment. The control flowchart illustrated in FIG. 6 is executed in coordination via communication between the CPU and control circuit of each control apparatus. Referring to FIGS. 7 to 11, illustrations of the hand base 301 and a sheet metal part are omitted.

The flowchart in FIG. 6 will now be described. In step S1, the control apparatus 500 positions the finger portions 311 and 312 at positions above a plurality of E-rings that are stacked in alignment (FIG. 7) in a stacker.

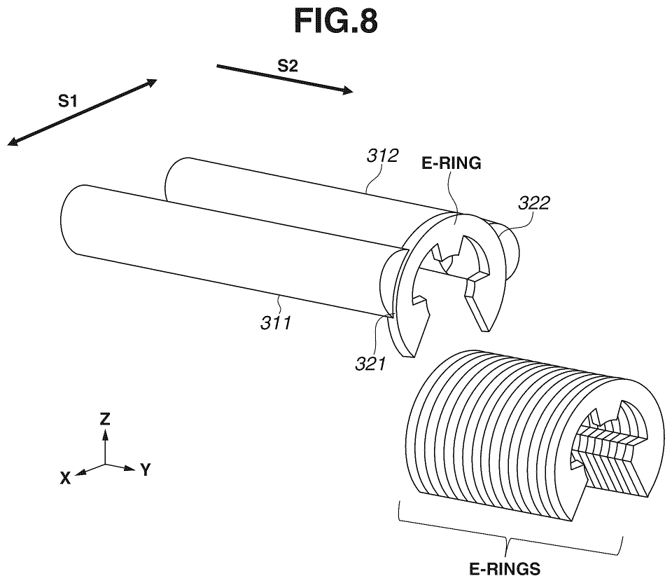

In step S2, the control apparatus 500 causes the finger portions 311 and 312 to grip one E-ring at an end of an E-ring from among the E-rings arranged in the stack (FIG. 8). More specifically, the control apparatus 500 brings the supporting surfaces 331 and 332 of the finger portions 311 and 312, respectively, into contact with a surface of the E-ring in the S2 direction. Then, the control apparatus 500 holds the side portions of the E-ring with the gripping surfaces 321 and 322 in the S1 direction to grip the E-ring. In this case, the thickness of the gripping surfaces 321 and 322 in the S2 direction is equal to or less than the thickness of a single E-ring so that only one of the plurality of E-rings is gripped. For example, a thickness of about 0.6 mm of the gripping surfaces 321 and 322 is desirable for a E-ring having a thickness of 0.7 mm and an inner diameter of 5 mm.

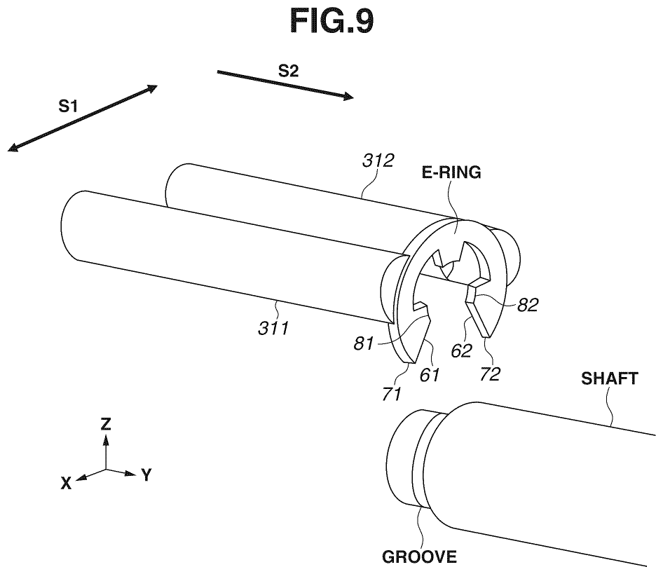

In step S3, while the E-ring is being gripped with the finger portions 311 and 312, the E-ring is conveyed to a position above the groove of the shaft to which the E-ring is to be attached (FIG. 9). Since the control apparatus 500 grips the E-ring with the finger portions 311 and 312 having relatively small sizes, the E-ring can access the shaft groove even if there is a drawn portion of the sheet metal part around the groove of the shaft to which the E-ring is to be attached.

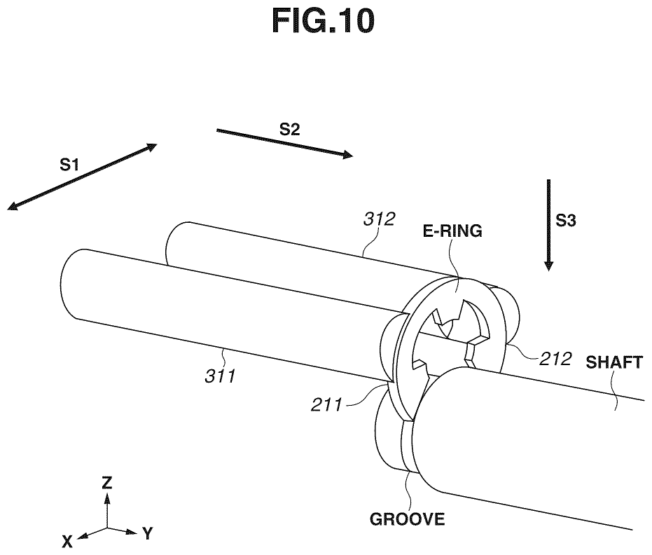

In step S4, while continuing to grip the E-ring, the control apparatus 500 moves the E-ring in the S3 direction so as to bring the E-ring into contact with the groove of the shaft (FIG. 10).

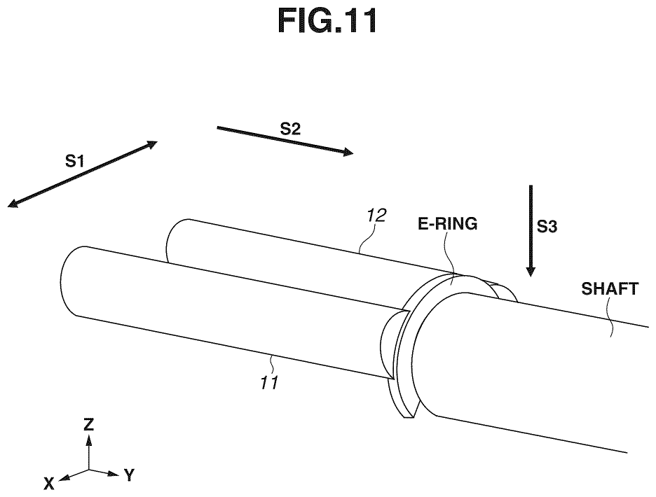

In step S5, the control apparatus 500 further moves the E-ring in the S3 direction to attach the E-ring to the shaft groove (FIG. 11). The processing of the control flowchart is ended.

In attaching the E-ring to the groove, the relief portions 341 and 342 formed on the finger portions 311 and 312, respectively, prevent interference between the shaft and the finger portions 311 and 312. When the E-ring is attached to the shaft groove, the notch surfaces 61 and 62 come into contact with the groove, and the notch surfaces 61 and 62 deform, causing the E-ring to open in the S1 direction. The amount of opening is greatest at the workpiece edges 71 and 72 on the notch surfaces of the E-ring. Thus, gripping the outer shapes near the workpiece edges 71 and 72 on the notch surfaces of the E-ring may hinder the deformation of the E-ring, potentially preventing the attachment of the E-ring to the shaft.

As described above, the finger portions 311 and 312 according to the present embodiment are formed with the edges 351 and 352, respectively, so as to grip the outer shape at positions spaced apart from the workpiece edges 71 and 72, respectively, on the notch surfaces of the E-ring, as illustrated in FIG. 5A. This reduces the influence of the gripping by the finger portions 311 and 312 on the deformation of the E-ring during the attachment, so that stable gripping of the E-ring during the attachment can be maintained. According to the present embodiment, the finger portions 311 and 312 are configured to slightly tilt in response to the deforming force of the E-ring, thus continuing to grip the E-ring in accordance with the amount of opening of the E-ring. Alternatively, the gripping control may be performed so as to increase the spacing between the finger portions in accordance with the deformation of the E-ring.

In a case where the E-ring is attached to the groove, the E-ring is not only deformed but also receives the attachment reactive force from the shaft. This attachment reactive force may deviate the E-ring from the gripping surfaces 321 and 322. Thus, the finger portions 311 and 312 according to the present embodiment are formed with the edges 361 and 362, respectively, so as to effectively receive the attachment reactive force, as illustrated in FIG. 5A. As a result, stable gripping of the E-ring can be maintained even when the attachment reaction force is applied.

According to the above described embodiment, the influence that gripping by the finger portions exerts on the deformation of the E-ring during attachment can be reduced, and the fingertip shape of the respective finger portions 311 and 312 is configured to withstand the reaction force during attachment of the E-ring. Thus, the E-ring can be gripped by the finger portions 311 and 312, and directly attached without releasing the grip.

Thus, even if a specialized tool cannot access the space where the E-ring is to be attached, the finger portions 311 and 312 can grip to attach the E-ring, making it possible to improve the versatility in E-ring attachment. The present embodiment is applicable not only to E-rings but also to U-shaped retaining rings and other retaining rings requiring an attachment method equivalent to that for E-rings.

### Second Embodiment

A second embodiment will now be described in detail. In the following descriptions, the same reference numerals will be used for configurations identical or equivalent to the first embodiment, and descriptions thereof will be omitted or simplified. The following descriptions will be made centering mainly on differences from the first embodiment.

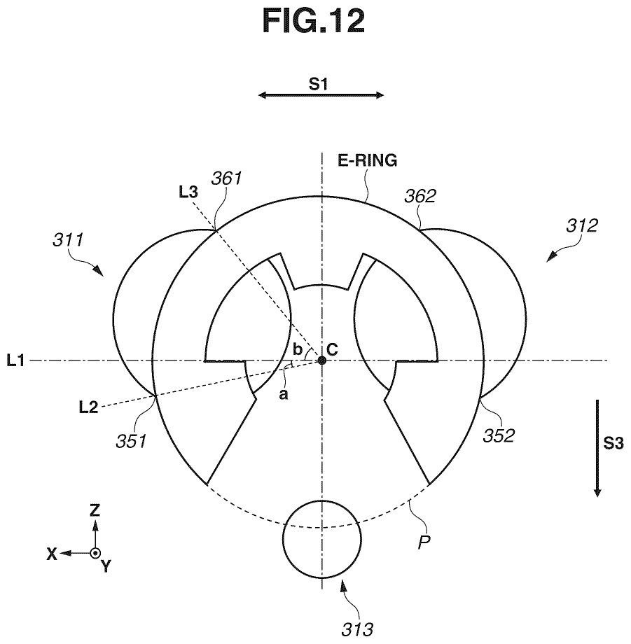

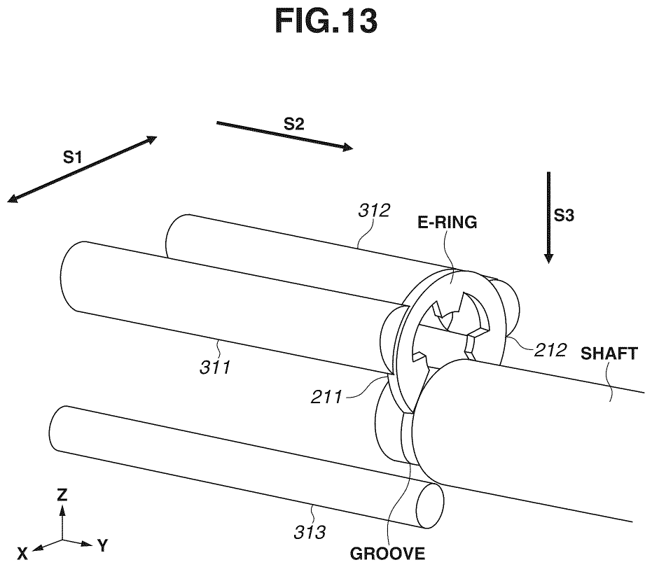

In the above-described first embodiment, an E-ring is attached by using two different finger portions. In the second embodiment, the E-ring may be gripped and attached by using three different finger portions depending on the E-ring attachment situation. FIG. 13 illustrates finger portions of the robot hand 300 according to the second embodiment. For conciseness, the hand base 301 is not illustrated in FIG. 13. Referring to FIG. 13, a finger portion 313 that is movable toward and away from the finger portions 311 and 312 in the S3 direction is arranged. As illustrated in FIG. 12, when the E-ring is brought into contact with the shaft, the finger portion 313 comes into contact with the shaft from a side opposite to where the finger portions 312 and 313 are disposed. Subsequently, the finger portions 311, 312, and 313 are operated so as to sandwich the E-ring and the shaft, thus performing E-ring attachment. More specifically, the E-ring is attached by bringing the finger portions 311, 312, and 313 close to each other. The finger portion 313 may be referred to as a third finger portion.

As described above, the influence that gripping by the finger portions exerts on the deformation of the E-ring during attachment can be reduced, and the fingertip shape of the respective finger portions is configured to withstand the reaction force during attachment of the E-ring. Thus, the E-ring can be gripped by the finger portions 311, 312, 313, to be directly attached without releasing the grip.

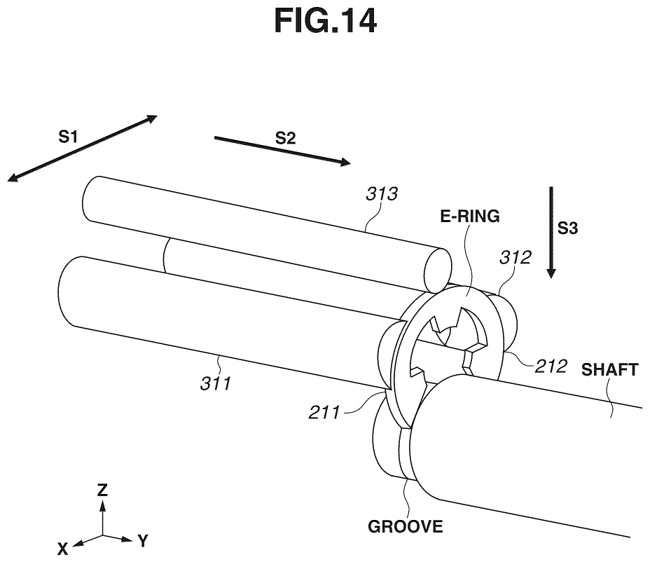

Therefore, even if a specialized tool cannot access the space where the E-ring is to be attached, the finger portions 311 and 312 can grip and attach the E-ring, thus improving versatility in the E-ring attachment. The finger portion 313 supports the shaft and helps reduce positional displacement in the S3 (Z) direction caused by the shaft bending during E-ring attachment. Since the finger portion 313 enters a small space, desirably, the finger portion 313 has a slightly smaller outer diameter than the finger portions 311 and 312. However, the present disclosure is not limited thereto. If the shaft bending is small and a space that allows access of the E-ring can be secured, the finger portion 313 may be disposed on the side on which the E-ring attachment reactive force is received, as illustrated in FIG. 14. This configuration can reduce the possibility of the positional displacement of the E-ring relative to the finger portions 312 and 313. The above-described different embodiments and modifications may be combined.

### Third Embodiment

A third embodiment will be described below. In the following descriptions, the same reference numerals will be used for configurations identical or equivalent to the above-described embodiments, and descriptions thereof will be omitted or simplified. The following descriptions will be made centering mainly on differences from the first embodiment.

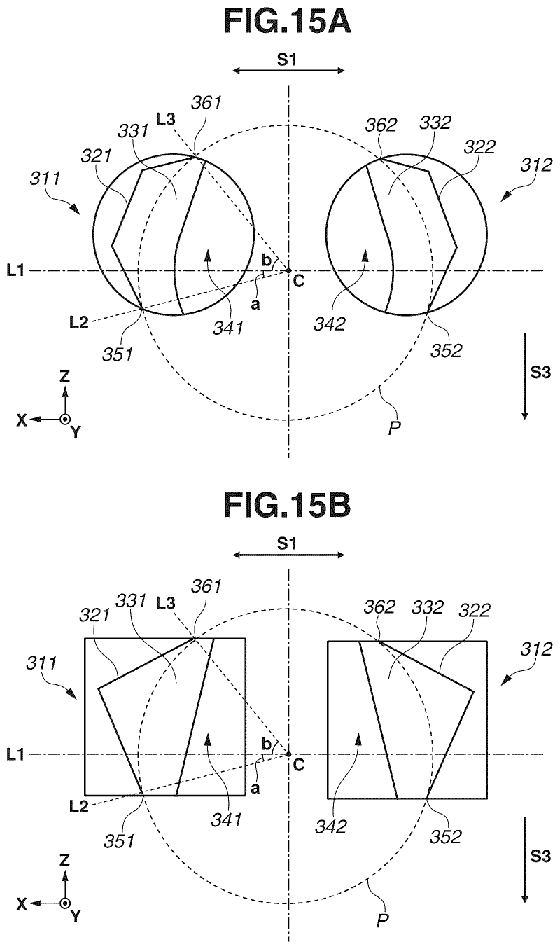

In the above-described embodiments, the gripping surface 321 connecting the edges 351 and 361, and the gripping surface 322 connecting the edges 352 and 362 have circular arc shapes. However, the shapes thereof are not so limited. As long as the angle a is smaller than the angle b, various shapes may be applicable. FIGS. 15A and 15B each illustrate the shapes of the finger portions 311 and 312 according to the third embodiment. For example, as illustrated in FIG. 15A, the gripping surfaces 321 and 322 may have polygonal (rectangular) shapes. As illustrated in FIG. 15B, the finger portions 311 and 312 may have rectangular shapes, and the gripping surfaces 321 and 322 may have polygonal (rectangular) shapes. The gripping surfaces 321 and 322 may have shapes that combine a circular arc shape and a rectangular shape.

According to the present embodiment described above, the influence that gripping by the finger portions exerts on the deformation of the E-ring during attachment can be reduced, and the fingertip shape of the respective finger portions is configured to withstand the reaction force during attachment of the E-ring. Therefore, even if a specialized tool cannot access the space where the E-ring is to be attached, the finger portions can grip and attach the E-ring, thus improving the versatility in the E-ring attachment. The above-described various embodiments and modifications may be combined.

### Fourth Embodiment

A fourth embodiment will be described below. In the following descriptions, the same reference numerals will be used for configurations identical or equivalent to the above-described embodiments, and descriptions thereof will be omitted or simplified. The following descriptions will be made centering mainly on differences from the first embodiment.

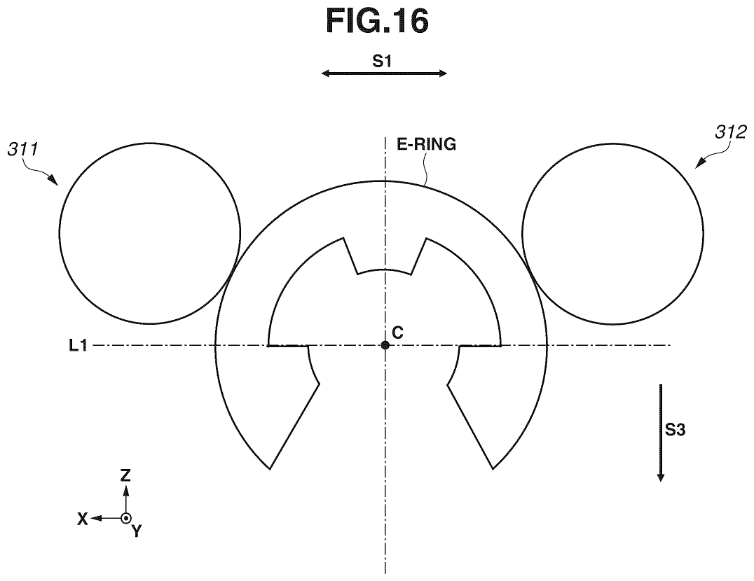

FIG. 16 illustrates the shapes of the finger portions 311 and 312 according to the fourth embodiment. According to the present embodiment, the finger portions 311 and 312 do not have the gripping surface 321 connecting the edges 351 and 361 or the gripping surface 322 connecting the edges 352 and 362, respectively, but rather have circular shapes. In a case where the E-ring is gripped with the finger portions 311 and 312, the contact points between finger portion 311 and the E-ring, and between finger portion 312 and the E-ring, are positioned on the opposite side in the S3 direction with respect to the center C of the E-ring. More specifically, the E-ring is gripped on the opposite side in the attachment direction with respect to the center C of the E-ring, so that the contact points between finger portions 311 and 312 and the E-ring can receive the reaction force generated during attachment of the E-ring. In a case where the E-ring has a low rigidity, the E-ring may be held and attached using the outer diameter portions of the finger portions 311 and 312 without using the edges. Although, in FIG. 16, the finger portions 311 and 312 have circular shapes, the finger portions may have rectangular shapes.

According to the present embodiment described above, the influence that gripping by the finger portions exerts on the deformation of the E-ring during attachment can be reduced. Furthermore, the gripping method is designed to withstand the reaction force generated during E-ring attachment. This enables the finger portions 311 and 312 to attach the E-ring while gripping the E-ring. Therefore, even if a specialized tool cannot access the space where the E-ring is to be attached, the finger portions can grip and attach the E-ring, thus improving the versatility in the E-ring attachment. The above-described various embodiments and modifications may be combined.

### Other Embodiments

Processing according to the above-described embodiments is executed by the CPU of each control apparatus. Therefore, an embodiment can be configured to read a control program of software for implementing the above-described functions from a recording medium and then execute the program. In this case, the control program itself read from the recording medium will implement the functions of the above-described embodiments, and the control program itself and the recording medium recording the relevant control program will configure the present disclosure.

Different embodiments have been described above centering on a case where a computer-readable recording medium is each ROM, each RAM, or each flash ROM, and programs are stored in the ROM, RAM, or flash ROM. However, the present disclosure is not limited to such a form. The program for implementing the present disclosure may be recorded in a computer-readable recording medium of any type, such as a Solid State Drive (SDD).

Although the above-described different embodiments are based on a case where the robot arm 200 is an articulated robot arm having a plurality of joints, the number of joints is not limited thereto.

A vertical multiaxial configuration has been described above as a robot arm type. Configurations equivalent to the above-described one are also applicable to joints of the horizontal articulated type, parallel link type, orthogonal robot type, and other different types.

The above-described different embodiments are applicable to machines capable of automatically performing expansion, contraction, vertical movement, horizontal movement, rotating motion, and a combination of these based on information in the storage device provided in the control apparatus 500.

The present disclosure is not limited to the above-described embodiments but can be modified in diverse ways without departing from the technical concepts of the present disclosure. Effects according to the above-described embodiments are to be considered as merely an enumeration of most desirable effects derived from the present disclosure, and effects of the present disclosure are not limited to those according to the embodiments of the present disclosure. The above-described different embodiments and modifications may be implemented in a combination.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-185008, filed Oct. 21, 2024, which is hereby incorporated by reference herein in its entirety.

What is claimed is:

1. A robot hand comprising:
a first finger portion and a second finger portion configured to grip a workpiece by approaching each other or separating from each other in a first direction,
wherein each of the first finger portion and the second finger portion is provided with at least two edges configured to contact the workpiece, with an arc passing through at least three of the edges, and
wherein, in the first direction, an edge among the at least three edges is provided on a side of a center of the arc opposite to a second direction in which the workpiece is to be attached, with the at least three of the edges being located on a side of the center of the arc in the second direction.

2. The robot hand according to claim 1, wherein, in the first direction, an edge, among the at least two edges, that is located on the opposite side in the second direction, with respect to the center and an edge, among the at least two edges, that is located on the side of the center of the arc in the second direction, with respect to the center, are positioned on the center side of a point on the first finger portion or the second finger portion farthest from the center of the arc.

3. The robot hand according to claim 1, wherein a midpoint between an edge, among the at least two edges, that is located on a first side in the second direction and another edge, among the at least two edges, that is located on a second side in the second direction are positioned on opposite sides of the attached workpiece.

4. The robot hand according to claim 1, wherein:
a first angle is formed by a first line segment and a second line segment,
a second angle is formed by the first line segment and a third line segment, with the first angle being smaller than the second angle,
the first line segment passes through the center of the arc and is parallel to the first direction,
the second line segment connects the center of the arc and an edge, among the at least two edges, that is located on the first finger portion on a forward side of the center in the second direction, and
the third line segment connects the center of the arc and another edge, among the at least two edges, that is located on the first finger portion on an opposite side of the center in the second direction.

5. The robot hand according to claim 1, wherein:
the first finger portion includes a first relief portion,
the second finger portion includes a second relief portion, and
in a case where the workpiece is brought into contact with another workpiece, the first relief portion and the second relief portion are configured to avoid interference between the another workpiece and at least one of the first finger portion and the second finger portion.

6. The robot hand according to claim 1,
wherein the first finger portion has a first surface connecting the at least two edges provided thereon, and
wherein the second finger portion has a second surface connecting the at least two edges provided thereon.

7. The robot hand according to claim 6,
wherein the first finger portion has a third surface for supporting the workpiece, different from the first surface, and
wherein the second finger portion has a fourth surface for supporting the workpiece, different from the second surface.

8. The robot hand according to claim 7,
wherein a length from the first surface to the third surface is equal to or less than a thickness of the workpiece, and
wherein a length from the second surface to the fourth surface is equal to or less than the thickness of the workpiece.

9. The robot hand according to claim 7, wherein the first surface and the second surface are gripping surfaces configured to grip the workpiece, and the third surface and the fourth surface are supporting surfaces configured to support the workpiece in a gripping state.

10. The robot hand according to claim 6, wherein the first surface and the second surface have at least one of a circular arc shape and a rectangular shape.

11. The robot hand according to claim 1, wherein the at least two edges include an edge on which a force generated by a deformation of the workpiece is received, and an edge on which a force generated during attachment of the workpiece is received.

12. The robot hand according to claim 1, further comprising:
a third finger portion configured to contact another workpiece, in a case where the workpiece contacts the another workpiece in a state where the workpiece is gripped by the first finger portion and the second finger portion.

13. The robot hand according to claim 1, wherein the workpiece is one of an E-shaped and a U-shaped retaining ring.

14. A robot hand comprising a first finger portion and a second finger portion configured to grip a workpiece by approaching each other or separating from each other, wherein a point where the first finger portion contacts the workpiece and another point where the second finger portion contacts the workpiece are positioned on opposite sides in a direction in which the workpiece is to be attached with respect to a center of the workpiece.

15. A robot system comprising:
the robot hand according to claim 1; and
a robot arm.

16. A method for manufacturing an article using the robot system according to claim 15.

17. A method for controlling a robot hand including a first finger portion and a second finger portion configured to grip a workpiece by approaching each other or separating from each other in a first direction,
wherein each of the first finger portion and the second finger portion is provided with at least two edges configured to contact the workpiece, and
wherein, in the first direction, an edge on a side opposite to a second direction in which the workpiece is to be attached, with respect to a center of a circular arc passing through at least three of the edges is positioned on a center side of an edge, among the at least two edges, that is located on a forward side in the direction in which the workpiece is to be attached, with respect to the center, the method comprising,
gripping the workpiece using the first finger portion and the second finger portion.

18. A method for controlling a robot hand including a first finger portion and a second finger portion configured to grip a workpiece by approaching each other or separating from each other in a first direction,
wherein a contact point where the first finger portion comes into contact with the workpiece and another contact point where the second finger portion comes into contact with the workpiece are positioned on opposite sides in a direction in which the workpiece is to be attached with respect to a center of the workpiece, the method comprising,
gripping the workpiece using the first and the second finger portions.

19. A non-transitory computer-readable recording medium storing a control program executable to perform the control method according to claim 18.
